(19) United States
(12) Patent Application Publication
(10) Pub. No.: US 2009/0114539 A1
(43) Pub. Date: May 7, 2009

(54) MIXTURE POTENTIAL SENSOR FOR MEASURING A GAS CONCENTRATION AND A METHOD FOR THE PRODUCTION THEREOF

(75) Inventors: Joerg Ziegler, Rutesheim (DE); Mario Roessler, Dobra Voda U Ceskych Budejovic (CZ)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/090,803

(22) PCT Filed: Sep. 22, 2006
(86) PCT No.: PCT/EP2006/066650

§ 371 Date: Oct. 8, 2008

(30) Foreign Application Priority Data
Oct. 18, 2005 (DE) 10 2005 049 775.6

(51) Int. Cl. G01N 27/26; B05D 5/12

(52) U.S. Cl. 204/424; 427/125

(57) ABSTRACT

A sensor for measuring a gas component concentration in a mixture comprises a ion conductor solid electrolyte and electrodes separated therefrom, wherein the external electrode is exposed to the mixture and the internal electrode is arranged in a hollow chamber separated from the mixture by a diffusion barrier and the invention is characterized in that the external electrode is provided with a solid body for forming the mixture potential.

### STATE OF THE ART

The invention concerns a sensor for measuring the concentration of a gas component in a gas mixture according to the generic term of claim 1. The invention further concerns a method for the production of an electrode of such a sensor according to the generic term of claim 6.

A familiar sensor that is used for the regulation of the air-fuel ratio of combustion mixtures for combustion engines originates for example from DE 101 56 248 C1.

Such a sensor presents a heated zirconium oxide element with a cavity, which is connected with the exhaust gas of the combustion engine by a diffusion barrier as well as a reference electrode, an inner pump electrode and an outer pump electrode. All electrodes consist of platinum (cermet). The reference electrode is arranged in an air reference channel or is created by a so-called pumped reference. By applying an electrical voltage between the inner pump electrode and the outer pump electrode oxygen can be pumped out of the cavity or pumped into the cavity. If the outer pump electrode has a positive electrical potential towards the inner pump electrode, oxygen is pumped out of the cavity. With a growing voltage the current advances until it is limited by the post flow through the diffusion barrier (limiting current area). The pump current between the inner and the outer pump electrode is so adjusted by a control loop that a constant preset Nernst voltage between the reference electrode and the inner pump electrode is measured throughout. The quantity of the required pump current depends on the oxygen content that is in the exhaust gas and therefore on the lambda-value. Compared to the spring probe, whose signal jumps abruptly at λ=1 from a very high value to a very low value, the signal of such a sensor, also called wide band lambda probe (LSU), is basically stable.

During the transition from a rich to a lean gas mixture the signal of the pump current over the time at about λ=1 shows an overshoot or undershoot, which are labeled as λ−1-waviness. This λ−1-waviness is interfering especially during the administration for the single cylinder detection. FIG. 1 schematically shows the signal course during the occurrence of such a λ−1-waviness, which is labeled with the reference sign 10 in FIG. 1.

The invention is therefore based on the task to improve such a sensor, as described above, and to provide a method for its production, so that the interfering λ−1-waviness is reduced.

### ADVANTAGES OF THE INVENTION

This task is solved by a sensor with the characteristics of the independent claim 1 as well as by a method with the characteristics of claim 6.

Advantageous improvements and configurations are the subject-matter of the claims that are based and dependent on the independent claims.

The basic idea of the invention is to generate the outer pump electrode from a solid-state, which leads to the producing of mixture potentials. By this means the jump of the effective pump voltage at λ=1 is eliminated or at least substantially reduced and thereby the λ−1-waviness minimized.

During an advantageous embodiment the solid-state is created by a platinum-gold-alloying.

During another embodiment the solid-state creates a ceramic electrode.

During yet another embodiment the solid-state is created by an oxidic electrode.

During another very advantageous embodiment, that is extremely easy to prepare, the solid-state consists of a platinum electrode, on which a deposition of gold takes place. The deposition of gold can either occur by a galvanic displacement of gold on the platinum electrode or by a decomposition of a gold salt, for example HAuCL₄, in a post-firing-process on the platinum electrode.

According to another advantageous embodiment the solid-state can also be produced by a platinum-gold paste that is treated by a cofiring. In this case the platinum-gold paste is spread on the outside of the zirconium-oxide and is transformed into a solid-state by the cofiring. Gold contents between 0.1 and wt 10%, especially 1-5 wt %, have proved to be very advantageous.

### DRAWING

Further advantages and characteristics of the invention are the subject-matter of the following description and of the graphic of embodiments of a sensor according to this invention.

The drawings show:

FIG. 1 schematically a λ−1-waviness of the pump current over the time, as it is already known from the state of the art;

FIG. 2 schematically cut a sensor making use of this invention;

FIG. 3 schematically the pump current over the time at a sensor element with a platinum outer electrode and

FIG. 4 the pump current over the time at a sensor element with a platinum outer electrode, which was galvanically gold-plated by a deposition of gold.

### DESCRIPTION OF EMBODIMENTS

The sensor that is shown in FIG. 2 embraces a zirconium oxide element 120, which is heated by a heater that has been established by heating elements 190. This zirconium oxide element presents a cavity 130, which is connected with the exhaust gas of e.g. a (not shown) combustion engine by a diffusion barrier 150, as well as a reference electrode 140, an inner pump electrode 170 and an outer pump electrode 160.

The reference electrode 140 and the inner pump electrode 170 consist of platinum (cermet). The reference electrode 140 is located in an air reference channel 180 and can be also built as a so-called pumped reference. By applying an electrical voltage at the feed line 161, 151 between the inner pump electrode 170 and the outer pump electrode 160 oxygen can be pumped out of the cavity 130 or pumped into the cavity 130. If the outer pump electrode 160 is electrically positive towards the inner pump electrode, oxygen is for example pumped out of the cavity 130. With a growing voltage the current now rises until it is limited by the post flow through the diffusion barrier 150 (limiting current area). A (not shown) control loop regulates the pump current Iₚ between the inner pump electrode 170 and the outer pump electrode 160, so that a constant, preset Nernst voltage UN is always measured between the reference electrode 140 and the inner pump electrode 170. The quantity of the required pump current Iₚ depends on the oxygen content that is present in the exhaust gas and therefore on the λ-value. Compared with a spring probe that is known from the state of the art and that abruptly jumps at λ=1 from a very high signal to a very low signal, the signal of this sensor, which is also known as a wide band lambda probe, is basically constant.

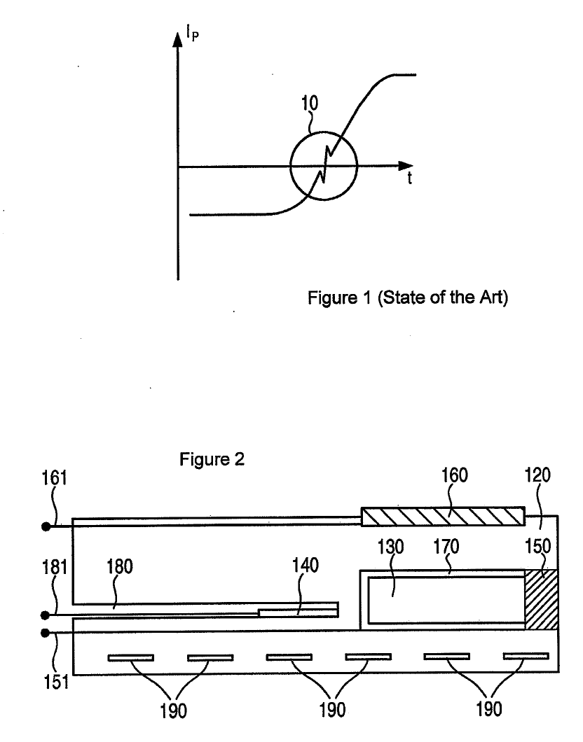

During the transition from a rich to a lean mixture an overshoot or undershoot, which are shown in FIG. 1 and which are known as λ−1-waviness, occur at about λ=1 in the signal of the pump current Iₚ over the time. This λ−1-waviness is especially interfering with the implementation of the single cylinder detection.

To avoid such a λ−1-waviness the invention provides that the outer pump electrode 160 is built by a solid-state, which leads to the creation of mixture potentials. Thereby the invention is based on the knowledge that the observed λ−1-waviness is built by the interaction of probe and control unit, whereby it is considered that also the outer pump electrode 160 is capacitive coupled onto the reference electrode 140. It is established that the size of the jump is influenced by the jump of the Nernst voltage, which depends only on the oxygen partial pressure when using a pure platinum electrode. The potential of mixture potential electrodes depends on the other side on the concentration of several exhaust gas components. For this reason the jumps in the signal of the pump current or the pump voltage, which are called as λ−1-waviness, do not occur when using a mixture potential electrode as an outer pump electrode 160.

Mixture potential electrodes are principally not balance electrodes. The thermo dynamic balance at the inner pump electrode 170 has to be adjusted for determining the λ-value. This does not have to be the case at the outer pump electrode 160, where a gas exchange takes place. The electrode can also be a solid-state here, which builds a mixture potential with the other exhaust gas components. The solid-state has only to be so chosen that the pump ability of the outer pump electrode 160 is adequately big enough. By building the outer pump electrode 160 as a mixture potential electrode the jump, which is shown in the signal of the effective pump voltage at λ=1, is eliminated or substantially reduced.

The outer pump electrode 160 can be build by a solid-state, which consists of a platinum-gold alloying. It is also possible to build the outer pump electrode 160 as a ceramic or oxidic electrode.

Preferably the outer pump electrode is thereby implemented, in that a galvanic deposition of gold takes place at a familiar platinum solid-state. It is also possible to modify the platinum electrode by an impregnating process, meaning to impregnate the platinum electrode with an appropriate Au-salt, for example HAuCl₄ and to decompose the Au-salt in a post-firing-process. It is further possible to spread a platinum-gold paste that is transformed by a cofiring in a solid-state, which builds the outer pump electrode 160, on the zirconium-oxide ceramic. Au-contents of 0.1-10 wt %, especially 1-5 wt % in the platinum-gold-paste proved themselves as advantageous.

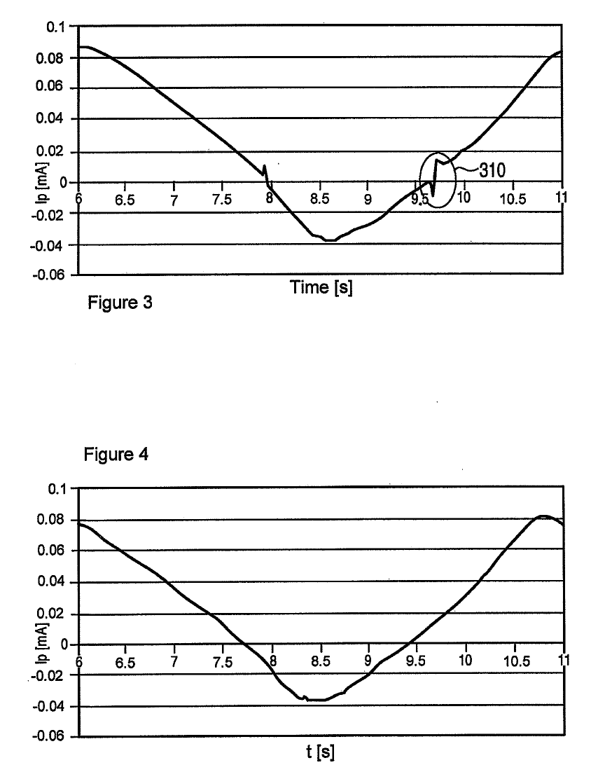

FIG. 3 shows the signal course of the pump current Iₚ over the time of a sensor, which has a platinum outer electrode as known from the state of the art. The pump current clearly shows here the previously described λ−1-waviness, which is labeled with the reference sign 310 in FIG. 3.

FIG. 4 shows the pump current over the time of the sensor shown in FIG. 3, whereby the outer electrode was gold-plated by a deposition of gold. After the galvanic gilding of the outer pump electrode 160 a λ−1-waviness does not occur anymore.

A wide band lambda probe (LSU) with an outer electrode that is build as a mixture potential electrode was previously described. It shall be understood that the invention is not limited to such a wide band lambda probe. It is principally also possible to provide the pump probe (LSP) with a mixture potential pump electrode, especially with a platinum-gold electrode, in order to minimize signal discontinuities.

1-6. (canceled)

7. A sensor that measures a concentration of a gas component in a gas mixture, the sensor comprising:
a solid-state electrolyte that is ionic conductive;
a plurality of electrodes, which are separated from each other by the solid-state electrolyte, including at least an outer electrode that is exposed to an exhaust gas and an inner electrode arranged in a cavity, the inner electrode separated from the gas mixture by a diffusion barrier, wherein a mixture potential is realized as a result of the outer electrode consisting of a solid-state.

8. A sensor according to claim 1, wherein the solid-state outer electrode comprises a platinum-gold alloying.

9. A sensor according to claim 1, wherein the solid-state outer electrode comprises a ceramic.

10. A sensor according to claim 1, wherein the solid-state outer electrode is an oxidic electrode, the oxidic electrode comprising at least one form of oxide.

11. A sensor according to claim 1, wherein the solid-state comprises a platinum electrode, wherein gold is deposited on the platinum electrode.

12. A method of fabricating an electrode of a sensor for measuring a concentration of a gas component in a gas mixture, wherein the sensor includes a solid-state electrolyte that is ionic conductive and a plurality of electrodes that are separated from each other by the solid-state electrolyte, including at least an outer electrode that is exposed to an exhaust gas and an inner electrode arranged in a cavity, the inner electrode separated from the gas mixture by a diffusion barrier, wherein a mixture potential is realized as a result of the outer electrode consisting of a solid-state, the method comprising:
spreading a platinum-gold paste on the solid-state electrolyte, wherein the platinum-gold paste build the outer electrode; and
annealing the platinum-gold paste.
